(19) United States
(12) Patent Application Publication
(10) Pub. No.: US 2014/0220488 A1
(43) Pub. Date: Aug. 7, 2014

(54) IMAGE FORMING METHOD

(71) Applicant: Konica Minolta, Inc., Tokyo (JP)

(72) Inventors: Yukio HOSOYA, Tokyo (JP); Futoshi KADONOME, Tokyo (JP); Kazue NAKAMURA, Tokyo (JP); Saburou HIRAOKA, Tokyo (JP); Yasuko UCHINO, Tokyo (JP)

(73) Assignee: Konica Minolta, Inc., Tokyo (JP)

(21) Appl. No.: 14/159,045

(22) Filed: Jan. 20, 2014

(30) Foreign Application Priority Data
Feb. 6, 2013 (JP) 2013-021201

(51) Int. Cl. G03G 21/00

(52) U.S. Cl. CPC G03G 21/0011
USPC 430/119.71; 430/119.7

(57) ABSTRACT

Provided is an image forming method, in which excellent cleaning properties are obtained for a long period of time even when the process is employed to an image forming apparatus with a charging roller for charging a photoreceptor, and a favorable image can be formed while inhibiting occurrence of a black spots-like image defect even in a high temperature and high humidity environment. In the image forming method, charging of a photoreceptor in a charging step is performed by a charging roller. A toner for electrostatic image development includes toner base particles added with an external additive. The external additive contains at least first external additive particles composed of a polytetrafluoroethylene and second external additive particles composed of at least one selected from a fatty acid metal salt and an amide wax. The number average molecular weight of the polytetrafluoroethylene constituting the first external additive particles is 500 to 20,000, and the second external additive particles are added in a ratio of 0.01 to 0.5 parts by mass per 100 parts by mass of the toner base particles.

### TECHNICAL FIELD

The present invention relates to an image forming method of an electrophotographic system.

### BACKGROUND ART

It is conventionally known that in an image forming apparatus of an electrophotographic system, such as a copying machine and a printer, a lubricant is used to reduce a frictional force between a photoreceptor and a cleaning blade so that cleaning properties are maintained.

The method of supplying a lubricant to a photoreceptor may largely include three types of methods, i.e., (1) a method of coating a photoreceptor with a lubricant using an applicator, (2) a method of containing a lubricant in a surface layer of a photoreceptor, and (3) a method of adding a lubricant as an external additive to a developer that contains a toner (for example, see Patent Literatures 1 to 3).

However, in the method of (1) described above, the apparatus unavoidably increases in size and is complicated. Also, coating unevenness occurs as an applicator deteriorates, and an excessively supplied lubricant slips through a cleaning blade causing contamination of a charging roller. Furthermore, a lubricant needs to be additionally replenished in some cases. Therefore, there is a problem in that maintenance becomes complex. Also, in the method of (2) described above, there is a problem in that charging properties on the surface of a photoreceptor becomes non-uniform, causing defects in image quality to easily occur. Also, there is another problem in that occurrence of unevenness in charging properties on the photoreceptor surface, which depends on an image history, causes image deletion to easily occur.

In the method of (3) described above, there are advantages such as miniaturization of an apparatus and simple supply of a lubricant on a photoreceptor.

On the other hand, as a charging device to be mounted to an image forming apparatus of an electrophotographic system, a device utilizing a corona discharge phenomenon, soon as a scorotron charging device, has been conventionally used in many cases. However, when the charging device utilizing a corona discharge phenomenon is used, there is a problem in that ozone and nitrogen oxides are generated during image formation processing. In contrast, when a charging device of a charging roller system is used, generation of ozone and nitrogen oxides can be substantially reduced. In the charging device of a charging roller system, charging of a photoreceptor is performed by bringing a conductive charging roller into proximity to or contact with the photoreceptor. For this reason, the charging device of a charging roller system, which also has excellent power source efficiency, is recently becoming the mainstream.

However, in the charging device utilizing such a charging roller, since the charging roller is in proximity to or in contact with a photoreceptor, enormous discharge energy is given in a lubricant on the photoreceptor, causing discharge degradation of the lubricant. As a result, there is a problem in that a lubrication effect is unlikely to be stably exerted.

### CITATION LIST

### Patent Literature

Patent Literature 1: Japanese Patent Application Laid-Open No. 2010-231078

Patent Literature 2: Japanese Patent Application Laid-Open No. 2010-185999

Patent Literature 3: Japanese Patent Application Laid-Open No. 2012-159742

### SUMMARY OF INVENTION

### Technical Problem

The inventors have found that the above-described problems can be solved by using as a lubricant a substance having large bond energy between constituent atoms and less influence by discharge degradation. An example of such a substance includes polytetrafluoroethylene particles.

However, in order to obtain desired cleaning properties when polytetrafluoroethylene particles are used, an added amount thereof needs to be increased. However, when an excess amount of a lubricant exists on a photoreceptor in a high temperature and high humidity environment, an aggregate of toner particles is formed. Accordingly, there is a problem in that a black spots-like image defect occurs on a fixed image. Therefore, there arises a new problem in that when polytetrafluoroethylene particles are added in a large amount to obtain desired cleaning properties, the black spots-like image defect cannot be prevented from occurring.

The present invention has been made in view of the foregoing circumstances, and has as its object the provision of an image forming method, in which excellent cleaning properties are obtained for a long period of time even when the process is employed to an image forming apparatus with a charging roller for charging a photoreceptor, and a favorable image can be formed while inhibiting occurrence of a black spots-like image defect even in a high temperature and high humidity environment.

### Solution to Problem

The image forming method according to the present invention includes a charging step of charging a photoreceptor, an exposing step of exposing the charged photoreceptor to light to form an electrostatic latent image, a developing step of developing the electrostatic latent image with a toner for electrostatic image development, a transferring step of transferring the developed toner image on a transfer material, and a cleaning step of cleaning a surface of the photoreceptor by a cleaning blade after transferring of the toner image. In the image forming method,

charging the photoreceptor in the charging step is performed by a charging roller;

the toner for electrostatic image development, which is used in the developing step, includes an external additive added to toner base particles, and the external additive contains at least first external additive particles composed of a polytetrafluoroethylene and second external additive particles composed of at least one selected from a fatty acid metal salt and an amide wax;

the polytetrafluoroethylene constituting the first external additive particles has a number average molecular weight of 500 to 20,000; and

the second external additive particles are added in a ratio of 0.01 to 0.5 parts by mass per 100 parts by mass of the toner base particles.

In the image forming method according to the present invention, the number average molecular weight of the polytetrafluoroethylene constituting the first external additive particles is preferably 1,000 to 5,000.

In the image forming method according to the present invention, the polytetrafluoroethylene constituting the first external additive particles is preferably added in an added amount of 0.01 to 1.0 parts by mass per 100 parts by mass of the toner base particles.

In the image forming method according to the present invention, the external additive preferably further contains calcium titanate particles.

In the image forming method according to the present invention, the photoreceptor has a protective layer on an organic photosensitive layer, and

the protective layer preferably contains a resin component obtained by curing a polymerizable compound that has at least an acryloyl group or a methacryloyl group, and inorganic fine particles treated with a surface treatment agent that has a polymerizable functional group.

In the image forming method according to the present invention, the first external additive particles preferably have a number average particle size of 0.5 to 20 μm.

In the image forming method according to the present invention, the second external additive particles is preferably added in an added amount of 0.01 to 0.5 parts by mass per 100 parts by mass of the toner base particles.

In the image forming method according to the present invention, a ratio by mass between the added amount of the first external additive particles and the added amount of the second external additive particles, i.e., (the added amount of the first external additive particles/the added amount of the second external additive particles), is preferably 0.1 to 10.

In the image forming method according to the present invention, the second external additive particles preferably have a number average particle size of 0.5 to 20 μm.

### Advantageous Effects of Invention

According to the image forming method of the present invention, an external additive is added to toner base particles. The external additive contains at least first external additive particles that include a specific polytetrafluoroethylene with a low molecular weight, and second external additive particles that include at least one selected from a fatty acid metal salt and an amide wax. Accordingly, excellent cleaning properties are obtained for a long period of time even when the process is employed to an image forming apparatus with a charging roller for charging a photoreceptor, and a favorable image can also be formed while inhibiting occurrence of a black spots-like image defect even in a high temperature and high humidity environment.

### BRIEF DESCRIPTION OF DRAWINGS

FIG. 1 is an explanatory sectional view illustrating an example of a structure of an image forming apparatus of a charging roller system used in an image forming method according to the present invention.

FIG. 2 is an explanatory sectional view illustrating an example of a structure of a charging roller in the image forming apparatus shown in FIG. 1.

### DESCRIPTION OF EMBODIMENTS

The present invention will be specifically described below.

### Image Forming Method:

The image forming method according to the present invention is an image forming method of a charging roller system wherein charging of a photoreceptor in a charging step is performed by a charging roller in a common image forming method of an electrophotographic system.

The image forming method according to the present invention specifically has a charging step of uniformly charging a photoreceptor using a charging roller, an exposing step of exposing the uniformly charged photoreceptor to light to form an electrostatic latent image, a developing step of developing the electrostatic latent image with a toner for electrostatic image development described in detail below (hereinafter, also simply referred to as a “toner”), a transferring step of transferring a toner image obtained by the development on a transfer material such as a paper sheet, a fixing step of fixing the toner image transferred on the transfer material by a fixing treatment of a contact heating system, and a cleaning step of cleaning a surface of the photoreceptor by a cleaning blade after the toner image was transferred.

### Toner:

In the toner used in the image forming method according to the present invention, at least first external additive particles that include a specific polytetrafluoroethylene (PTFE) with a low molecular weight, and second external additive particles that include at least one selected from a fatty acid metal salt and an amide wax are added as an external additive to toner base particles in a specific addition ratio.

In the toner according to the present invention as described above, the first external additive particles composed of a polytetrafluoroethylene described above and the second external additive particles composed of a fatty acid metal salt and/or an amide wax are added as an external additive to the toner base particles. Accordingly, excellent cleaning properties are obtained for a long period of time even when the toner is employed to an image forming apparatus with a charging roller for charging a photoreceptor, and a favorable image can be formed while inhibiting occurrence of a black spots-like image defect even in a high temperature and high humidity environment.

Since the bond energy between a carbon atom and a fluorine atom of a polytetrafluoroethylene is large, discharge degradation of the polytetrafluoroethylene hardly occurs. Therefore, cleaning properties are not lost. Thus, the frictional force between a photoreceptor and a cleaning blade can be reduced. For this reason, it is considered that excellent cleaning properties can be obtained in the present invention.

In addition, by adding as an external additive the second external additive particles that include a fatty acid metal salt and/or an amide wax, together with the first external additive particles composed of a polytetrafluoroethylene, the added amount of the first external additive particles composed of a polytetrafluoroethylene can be suppressed to a small amount. As a result, a lubricant does not excessively exist on a photoreceptor even when image formation is performed in a high temperature and high humidity environment. Therefore, an aggregate of the toner base particles is not formed, and occurrence of a black spots-like image defect on a fixed image can be substantially suppressed.

The reason for this is not known, but is speculated as follows. That is, a polytetrafluoroethylene has a small intermolecular cohesion, and therefore is unlikely to adhere to a photoreceptor. For this reason, a frictional force between a photoreceptor and a cleaning blade cannot be usually reduced unless a large amount of polytetrafluoroethylene particles is added as an external additive. However, both a fatty acid metal salt and an amide wax have a strong adherence to a photoreceptor, and charging properties with an opposite polarity to a polytetrafluoroethylene. Therefore, by using the second external additive particles composed of a fatty acid metal salt and/or an amide wax in combination like the present invention, the fatty acid metal salt and/or the amide wax attract the polytetrafluoroethylene by an electrostatic attraction, and act as an adhesive between a photoreceptor and the polytetrafluoroethylene. As a result, the frictional force between a photoreceptor and a cleaning blade can be reduced by a small amount of the first external additive particles.

### First External Additive Particles:

A polytetrafluoroethylene constituting the first external additive particles has a number averaged molecular weight of 500 to 20,000, preferably 1,000 to 5,000.

By using the polytetrafluoroethylene that has a number average molecular weight in the above-described range, aggregation with toner base particles in a developing device is inhibited, and furthermore, favorable spreadability on a photoreceptor causes excellent cleaning properties to be obtained. When a polytetrafluoroethylene having a number average molecular weight of less than 500 is used, the polytetrafluoroethylene aggregates with the toner base particles in a developing device. When a polytetrafluoroethylene having a number average molecular weight of more than 20,000 is used, spreadability on a photoreceptor is low, and desired cleaning properties cannot be obtained.

The number average molecular weight of a polytetrafluoroethylene constituting the first external additive particles can be obtained in accordance with the method of S. Wu (Polymer Engineering & Science, 1988, vol. 28, 538, and 1989, Vol. 29, 273). This method is used for calculating a number average molecular weight, a weight average molecular weight and a molecular weight distribution from an elastic modulus of a molten resin. The method is especially useful for measuring a molecular weight of a resin which as insoluble in a solvent, represented by a polytetrafluoroethylene. Using a viscoelasticity measuring apparatus “MCF 500” manufactured by Anton Paar as a measuring device, a dynamic viscoelasticity at 380° C. is measured. In this case, a parallel plate is used as a jig for holding a sample. The thickness of a molten sample is set to be 1.4 to 1.5 mm, and the frequency is set in a range of 0.001 to 500 rad/sec. The deformation amount of a molten sample is selected from a range of 0.8 to 3% on a circumference when the frequency is not lower than 1 rad/sec, and is selected from a range of 2 to 10% when the frequency is not higher than 1 rad/sec, relative to a sample thickness. Also, the sampling frequency of a measurement value is 5 points per digit at a logarithmic equal interval. Also, measurement is repeated until the average of a deviation of a storage modulus (G′(ω)) for each measurement frequency (ω) in two consecutive measurements becomes not higher than 5%. Using a frequency (ω) and a storage modulus (G′(ω)) calculated by the measurement, a number average molecular weight (Mn) was calculated in accordance with the method of S. Wu under the condition of time t=1/ω and G(t)=G′(ω).

The number average particle size of toe first external additive particles as preferably 0.5 to 20 μm, more preferably 0.8 to 2 μm.

When the number average particle size of the first external additive particles is in the above-described range, the first external additive particles contained in a toner can easily move to a photoreceptor, and the cleaning properties of a photoreceptor can be stably improved. When the number average particle size of the first external additive particles is less than 0.5 μm, adhesion to toner particles becomes large. Accordingly, the first external additive particles act together with the toner particles even on a photoreceptor. Therefore, desired cleaning properties may not be exerted. Also, when the number average particle size of the first external additive particles is more than 20 μm, an aggregate of toner particles is likely to be formed on a photoreceptor. Therefore, a black spots-like image defect may occur on the obtained image.

The number average particle size of the first external additive particles is measured by an image analysis method.

Specifically, a picture of a toner is photographed at a magnification of 30,000 times using a scanning electron microscope, and the picture image is scanned. Using an image processing analyser “LUZEX AP (manufactured by Nireco Corporation)”, an external additive present on the surfaces of toner particles on the picture image is binarized. Then, with respect to any 100 first external additive particles, horizontal Feret diameters are calculated. An average thereof is determined as a number average particle size.

The added amount of the first external additive particles is preferably 0.01 to 1.0 parts by mass, more preferably 0.05 to 0.50 parts by mass, per 100 parts by mass of toner base particles.

When the added amount of the first external additive particles falls within the above-described range, the first external additive particles contained in the toner is likely to be stably supplied onto a photoreceptor. When the added amount of the first external additive particles is lower than 0.01 parts by mass, sufficient cleaning properties may not be obtained. When the added amount of the first external additive particles is higher than 1.0 part by mass, the toner may not have sufficient fluidity.

### Second External Additive Particles:

The added amount of the second external additive particles composed of a fatty acid metal salt and/or an amide wax is 0.01 to 0.5 parts by mass, preferably 0.02 to 0.2 parts by mass, per 100 parts by mass of toner base particles.

When the added, amount of the second external additive particles falls within the above-described range, desired cleaning properties can be obtained with addition of a small amount of the first external additive particles. When the added amount of the second external additive particles is less than 0.01 parts by mass, an adhesion effect between a photoreceptor and the first external additive particles cannot be sufficiently obtained. Thus, desired cleaning properties cannot be obtained. When the added amount of the second external additive particles is more than 0.5 parts by mass, charging properties of the toner decrease. Thus, toner scattering and fogging may be likely to occur.

The ratio between the added amount of the first external additive particles and the added amount of the second external additive particles also varies depending on particle sizes of the first external additive particles and the second external additive particles. However, the ratio by mass of the added amount of the first external additive particles to the added amount of the second external additive particles is preferably 0.1 to 10.

When the ratio between the added amount of the first external additive particles and the added amount of the second external additive particles falls within the above-described range, the first external additive particles composed of a polytetrafluoroethylene can surely adhere to a photoreceptor.

As examples of the fatty acid metal salt, may be mentioned zinc stearate, calcium, stearate, aluminum stearate, zinc laurate, and zinc myristate.

Also, as examples of the amide wax, may be mentioned methylenebis stearic acid amide, methylenebis capric acid amide, ethylenebis lauric acid amide, ethylenebis stearic acid, amide, ethylenebis behenic acid amide, and hexamethylenebis stearic acid amide.

These may be used either singly or in any combination thereof.

The number average particle size of the second external additive particles is preferably 0.5 to 20 μm, more preferably 0.8 to 2 μm.

When the number average particle size of second external additive particles falls within the above-described range, the first external additive particles can surely adhere to a photoreceptor. Thus, sufficient cleaning properties can be obtained with addition of a small amount of the first external additive particles. When the number average particle size of the second external additive particles is less than 0.5 μm, adhesion to toner particles becomes large. Accordingly, the second external additive particles act together with the toner particles even on a photoreceptor. Therefore, desired cleaning properties may not be exerted. Also, when the number average particle size of the second external additive particles is more than 20 μm, an image defect may occur.

The second external additive particles preferably have a number average particle size that is approximately equal to that of the first external additive particles. When the particle sizes of the first external additive particles and the second external additive particles are approximately equal to each other, the first external additive particles composed of a polytetrafluoroethylene can surely adhere to a photoreceptor.

The number average particle size of the second external additive particles can be obtained in the same manner as in the measurement method of a number average particle size of the first external additive particles described above, except that a horizontal Feret diameter is calculated with respect to 100 second external additive particles composed of a fatty acid metal salt and/or an amide wax.

### Other External Additives:

In the toner according to the present invention, the first external additive particles composed of a polytetrafluoroethylene and the second external additive particles composed of a fatty acid metal salt and/or an amide wax are added as external additives acting as a lubricant. However, external additives other than these may be contained. As other external additives, calcium titanate particles are preferably used.

When the calcium titanate particles are added as other external additives, the frictional force between a photoreceptor and a cleaning blade can be farther reduced. It is considered that this is because the calcium titanate particles form an aggregate with the first external additive particles composed of a polytetrafluoroethylene, and the aggregate efficiently moves from the surface of the toner particles to the surface of a photoreceptor.

Also, other than the above, may be contained other external additives chat improve charging properties and fluidity as a toner. Specifically, may be used inorganic oxide fine particles including silica fine particles, alumina fine particles, and titanium oxide fine particles, composite oxide fine particles thereof, organic fine particles, and the like.

The added amount of a total of the external additives including the first external additive particles, the second external additive particles, and other external additives according to the present invention is preferably 0.1 to 10.0 parts by mass per 100 parts by mass of toner base particles.

The toner base particles (hereinafter, also referred to as “toner particles”) contain at least a binder resin, and may contain, as necessary, internal additives such as a colorant, a parting agent and a charge control agent.

### Binder Resin:

The binder resin constituting toner particles is not particularly limited, and various known binder resins can be used. As examples of the binder resin, may be mentioned styrene resins, acrylic-based resins, styrene-acrylic-based resins, polyester resins, silicone resins, olefin resins, amide resins, and epoxy resins.

From the viewpoint of toner particle sizes as well as shape control properties and charging properties, styrene-acrylic-based resins are preferably contained as a binder resin.

Also, as examples of a polymerizable monomer for obtaining the styrene-acrylic-based resins, may be used styrene-based monomers such as styrene, methylstyrene, methoxystyrene, butylstyrene, phenylstyrene, and chlorstyrene; (meth)acrylate ester-based monomers such as methyl (meth)acrylate, ethyl (meth)acrylate, butyl (meth)acrylate and ethylhexyl (meth)acrylate; and carboxylic acid-based monomers such as acrylic acid, methacrylic acid and fumaric acid.

These may be used either singly or in any combination thereof.

The glass transition point (Tg) of the binder resin is preferably 30 to 50° C., more preferably 30 to 45° C.

When the glass transition point of the binder resin falls within the above-described range, low temperature fixability and neat-resistant storage properties are simultaneously obtained.

The glass transition point of the binder resin is measured using “Diamond DSC” (manufactured by PerkinElmer, Inc.).

In the measurement procedure, 3.0 mg of a sample (a binder resin) is sealed in an aluminum pan, and the pan is set in a holder. An empty aluminum pan was used as a reference. A measurement is performed under the condition of a measurement temperature of 0° C. to 200° C., a temperature rise rate of 10° C./min, a temperature drop rate of 10° C./min, and Heat-cool-Heat temperature control. An analysis is performed based on the data of the 2nd. Heat. An extension line of a base line before rising of the first endothermic peak and a tangent line indicating a maximum inclination in the range from a rising part to a peak top of the first endothermic peak are drawn. Then, an intersection point therebetween is shown as a glass transition point.

### Colorant:

When a colorant is contained in toner particles, commonly known dyes and pigments can be used as the colorant.

As examples of a colorant for obtaining a black toner, may be used publicly known various agents including carbon black such as furnace black and channel black, a magnetic body sack as magnetite and ferrite, a dye, and an inorganic pigment containing non-magnetic iron oxide.

As a colorant for obtaining a color toner, publicly known agents such as a dye and an organic pigment can be optionally used. Specifically, as examples of the organic pigment, may be mentioned C.I. Pigment Red 5, 48:1, 53:1, 57:1, 81:4, 122, 139, 144, 149, 166, 177, 178, 222, 238, and 269; C.I. Pigment Yellow 14, 17, 74, 93, 94, 138, 155, 180, and 185; C.I. Pigment Orange 31 and 43; and C.I. Pigment Blue 15:3, 60, and 76. As examples of the dye, may be mentioned C.I. Solvent Red 1, 49, 52, 58, 68, 11, and 122; C.I. Solvent Yellow 19, 14, 77, 79, 81, 82, 93, 98, 103, 104, 112, and 162; and C.I. Solvent Blue 25, 36, 69, 70, 93, and 95.

The colorants for obtaining each color toner may be used either singly or in any combination thereof for each color.

The content ratio of a colorant is preferably 1 to 10 parts by mass, more preferably 2 to 8 parts by mass, per 100 parts by mass of the binder resin.

### Parting Agent:

When a parting agent is contained in toner particles, as examples of the parting agent, may be mentioned polyolefin waxes such as polyethylene waxes and polypropylene waxes, branched-chain hydrocarbon waxes such as microcrystalline waxes, long-chain hydrocarbon-based waxes such as paraffin waxes and Sasol waxes, dialkyl ketone-based waxes such, as distearyl ketone, ester-based waxes such as Carnauba waxes, montan waxes, behenic acid behenate, trimethylolpropane tribehenate, pentaerythritol tetrabehenate, pentaerythritol diacetate dibehenate, glycerin tribehenate, 1,18-octadecanediol distearate, tristearyl trimellitate, and distearyl maleate, and amide-based waxes such as ethylenediamine behenyl amide and tristearyl trimellitate amide.

The content ratio of the parting agent is usually 1 to 30 parts by mass, sore preferably 5 to 20 parts by mass, per 100 parts by mass of the binder resin. When the content ratio of the parting agent falls within the above-described range, sufficient fixing separability can be obtained.

### Charge Control Agent:

When a charge control agent is contained in toner particles, commonly known various compounds can be used as the charge control agent.

The content ratio of the charge control agent is usually 0.1 to 5.0 parts by mass per 100 parts by mass of the binder resin.

### Average Particle Size of Toner Particles:

The toner particles according to the present invention have an average particle size of preferably 3 to 9 μm, more preferably 3 to 8 μm in terms of, for example, a volume-based median diameter. The particle size can be controlled by a concentration of a used aggregating agent, an added amount of an organic solvent, a fusion time, and a composition of a polymer when, for example, the particles are produced by adopting an emulsion aggregation method described later.

When the volume-based median diameter falls within the above-described range, transfer efficiency is increased to improve the quality of a half-tone image. Thus, an image quality of a fine line, a dot and the like is improved.

The volume-based median diameter of the toner particles is measured and calculated using a measuring device in which a computer system installed with a data processing software “Software V3.51” is connected to “Multisizer 3” (manufactured by Beckman Coulter, Inc.).

Specifically, 0.02 g of a sample (toner particles) was added in 20 mL of a surfactant solution, and the mixture was mixed thoroughly. The surfactant solution was obtained by, for example, diluting a neutral detergent containing a surfactant component 10 times with pure water for the purpose of dispersion of toner particles. Then, an ultrasonic dispersion was performed for one minute to prepare a dispersion liquid of toner particles. The dispersion liquid of toner particles was poured using a pipet in a beaker containing “ISOTON II” (manufactured by Beckman Coulter, Inc.) placed in a sample stand until the concentration displayed in the measuring device reaches 8%. Here, when the concentration falls within this range, a reproducible measurement value can be obtained. Then, in the measuring device, a frequency value is calculated under the condition of a measurement particle count number of 25,000, an aperture diameter of 50 μm, and a measurement range of 1 to 30 μm divided into 256 portions. A particle size corresponding to 50% from the largest volume-integrated fraction is defined as a volume-based median diameter.

### Average Roundness of Toner Particles:

From the viewpoint of improvement in transfer efficiency, the toner particles according to the present invention have an average roundness of preferably 0.930 to 1.000, more preferably 0.950 to 0.995.

In the present invention, the average roundness of toner particles is measured using “FPIA-2100” (manufactured by Sysmex Corporation).

Specifically, a sample (toner particles) is mixed thoroughly in an aqueous solution containing a surfactant. The mixture is subjected to an ultrasonic dispersion treatment for one minute for dispersion. Thereafter, using “FPIA-2100” (manufactured by Sysmex Corporation), photographing is performed under the measurement condition of an HPF (high magnification photographing) mode and at a proper concentration of an HPF detection number of 3,000 to 10,000. The roundness of each toner particle is calculated according to a following formula (T). The roundness of each toner particle is added to each other, and the added value is divided by a total number of toner particles, to thereby calculate an average roundness.

Roundness=(Perimeter of circle having the same projected area as particle image)/(Perimeter of particle projection image) Formula (T):

### Softening Point of Toner:

In order to sustain a toner having low temperature fixability, the softening point of the toner is preferably 80 to 120° C., more preferably 30 to 110° C.

The softening point of a tenor is measured, using a flow tester shown below.

Specifically, first, 1.1 g of a sample (a toner) was put in a petri dish and flattened in an environment of 20° C. and 50% RH. Then, the sample was left to stand for 12 hours or longer. Thereafter, the sample was pressurised for 30 seconds with a force of 3820 kg/cm² using a molding machine “SSP-10A” (manufactured by Shimadzu Corporation) to prepare a column-shaped molded sample having a diameter of 1 cm. Next, after preheating was completed, the molded sample was extruded through a hole (1 mm in diameter×1 mm) of a column-shaped die, using a piston having a diameter of 1 cm, under the condition of a load of 196N (20 kgf), an onset temperature of 60° C., a preheating time of 300 seconds and a temperature rise rate of 6° C./min, by a flow tester “CFT-500D” (manufactured by Shimadzu Corporation), in an environment of 24° C. and 50% RH. An offset method temperature T_{offset} measured by setting the offset value at 5 mm in a melting temperature measurement method of a temperature rise scheme is defined as a softening point.

### Toner Producing Process:

In the toner according to the present invention, at least the first external additive particles including the polytetrafluoroethylene and the second external additive particles including the fatty acid metal salt and/or the amide wax are added as external additives in toner base particles. The process of producing the toner particles is not particularly limited. As examples of the production process, may be mentioned publicly known methods such as a kneading and pulverizing method, a suspension polymerization method, an emulsion aggregation method, a dissolution suspension method, a polyester elongation method, and a dispersion polymerization method.

Among these, an emulsion aggregation method is preferably adopted from the viewpoint of a uniform particle size which is advantageous for obtaining high image quality and highly stable charge, shape control properties, and easy formation of a core-shell structure.

In an emulsion aggregation method, a dispersion liquid of binder resin fine particles (hereinafter, also referred to as “resin fine particles”) dispersed by a surfactant and a dispersion stabilizer is mixed with a dispersion liquid of a toner particle component such as colorant fine particles as necessary. Furthermore, by adding an aggregating agent, the aggregation is continued until a desired toner particle size is obtained. Thereafter or during the aggregation, fusion among the resin fine particles is performed, and the shape is controlled. Thus, toner particles are formed.

Here, the resin fine particles can be composite particles formed in multiple layers that include two or mere layers each being made of a resin having a different composition.

The resin fine particles can be produced by, for example, an emulsion polymerization method, a mini-emulsion polymerization method or a phase-transfer emulsification method, or a combination of some of the methods. When the resin fine particles contain an internal additive, a mini-emulsion polymerization method is preferably used among others.

When an internal additive is contained in toner particles, the resin fine particles may contain an internal additive. Alternatively, a dispersion liquid of internal additive fine particles consisting of only an internal additive may be separately prepared, and the internal additive fine particles may be aggregated during the aggregation of resin fine particles.

Also, when toner particles are configured to have a core-shell structure, resin fine particles each having a different composition may be aggregated by adding the resin fine particles at different times during aggregation.

In the obtained dried toner particles, the external additive containing at least a powder of the first external additive particles including the polytetrafluoroethylene and a powder of the second external additive particles including the fatty acid metal salt and/or the amide wax is added and mixed. In this dry method, an external additive is added. Thus, a toner to be used in the image forming method according to the present invention is produced.

As a mixing device of an external additive, may be used various publicly known mixing devices such as a Turbula mixer, a Henschel mixer, a Nauta mixer, and a V-type mixer.

### Developer:

The toner according to the present invention may be used as a magnetic or non-magnetic one-component developer as well as a two-component developer in which a carrier is mixed.

When the toner is used as a two-component developer, the mixed amount of the toner with respect to a carrier is preferably 2 to 10% by muss.

The mixing device for mixing a toner and a carrier is not particularly limited. As examples of the mixing device, may be mentioned a Nauta mixer, and a W-cone or V-type mixer.

The carrier preferably has an average particle size of 10 to 60 μm in terms of a volume based median diameter.

In the present invention, the volume based median diameter of the carrier is typically measured using a laser diffraction particle size distribution analyser “HELOS” (manufactured, by Sympatec GmbH) equipped with a wet disperser.

Also, as she carrier, a coated carrier including magnetic body particles as a core material (a core) and a surface coated with a resin is preferably used. The resin used for coating a core material is not particularly limited, and various resins can be used. For example, with respect to a toner configured to have positive charging properties, can be used fluorine-based resins, fluorine-acrylic acid-based resins, silicone-based resins, and modified silicone-based resins. Especially, a condensed silicone-based resin is preferably used. Also, for example, with respect to a toner configured to have negative charging properties, can be used styrene-acrylic-based resins, mixed resins of styrene-acrylic-based resins and melamine-based resins and cured resins thereof, silicone-based resins, modified silicone-based, resins, epoxy-based resins, polyester-based resins, urethane-based resins, and polyethylene-based resins. Among these, mixed resins of styrene-acrylic-based resins and melamine-based resins and cured resins thereof, as well as condensed silicone-based resins are preferably used.

When the toner according to the present invention is used as a two-component developer, the two-component developer can also be formed by further adding a charge control agent, an adhesion-improving agent, a primer treatment agent and a resistance control agent, as necessary, to the toner and the carrier.

### Image Forming Apparatus:

In an image forming apparatus used in the image forming method of the present invention, the charging system is a charging roller system. The image forming apparatus of such a charging roller system may nave a structure in which a charging roller is arranged so as to be in contact with or in proximity to a photoreceptor.

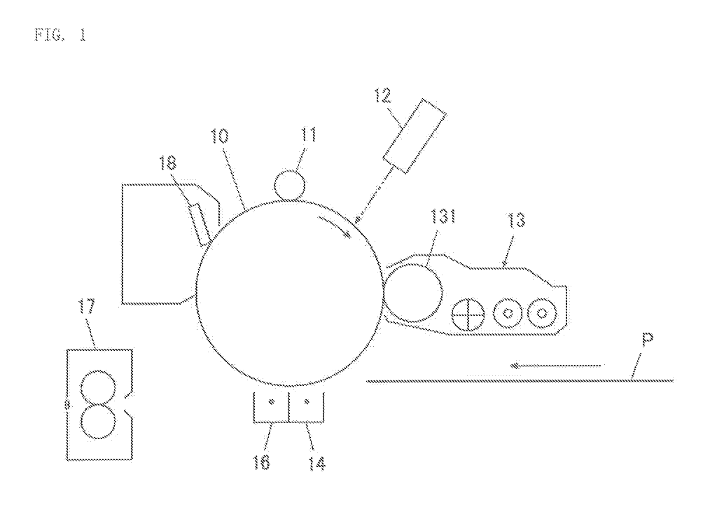

FIG. 1 is an explanatory sectional view illustrating an example of a structure of an image forming apparatus of a charging roller system used in the image forming method according to the present invention.

The image forming apparatus has a drum-shaped organic photoreceptor (hereinafter, also simply referred to as “photoreceptor”) 10 that is an electrostatic latent image carrying body, a charging unit including a charging roller 11 that provides a uniform potential on the surface of the photoreceptor 10 by, for example, corona discharge having the same polarity as a toner, an exposing unit 12 that performs image exposure on the surface of the uniformly charged photoreceptor 10 based on image data by a polygon mirror or the like to form an electrostatic latent image, a developing unit 13 that includes a development sleeve 131 to be rotated and delivers a toner held on the development sleeve 131 onto the surface of the photoreceptor 10 to visualize the electrostatic latent image and form a toner image, a transferring unit 14 that transfers the toner image onto a transfer material P as necessary, a separation unit 16 that separates the transfer material P from the photoreceptor 10, a fixing unit 17 that fixes the toner image on the transfer material P, and a cleaning unit having a cleaning blade 18 for removing a remaining toner on the photoreceptor 10.

### Photoreceptor:

The photoreceptor 10 used in the image forming method according to the present invention is an organic photoreceptor having an organic photosensitive layer and a protective layer formed thereon. The protective layer preferably contains a resin component including a crosslinked resin obtained by curing a polymerizable compound that has at least an acryloyl group or a methacryloyl group, and inorganic fine particles treated with a surface treatment agent that has a polymerizable functional group.

A layer structure of the organic photoreceptor is not particularly limited as long as the organic photosensitive layer and the protective layer are laminated in this order on a conductive support. Specifically, the organic photosensitive body having a layer structure of (1) or (2) as shown below may be mentioned.

(1) Layer structure in which an intermediate layer, a charge generation layer and a charge transport layer as an organic photosensitive layer, and a protective layer are laminated in this order on a conductive support.

(2) Layer structure in which an intermediate layer, a layer containing a charge generation substance and a charge transport substance as an organic photosensitive layer, and a protective layer are laminated in this order on a conductive support.

In the present invention, the organic photoreceptor is defined as being configured that at least one of a charge generation function and a charge transport function, both of which are essential in a structure of an electrophotographic organic photoreceptor, is exerted by an organic compound. The organic photoreceptor is any publicly known organic photoreceptor such as an organic photoreceptor having an organic photosensitive layer that includes a publicly known organic charge generation substance or a publicly known organic charge transport substance, and an organic photoreceptor having an organic photosensitive layer in which a charge generation function and a charge transport function are configured by a polymer complex.

The organic photosensitive layer can be prepared by various conventionally publicly known production methods using conventionally publicly known raw materials.

### Protective Layer:

The protective layer in an organic photoreceptor used in the image forming method according to the present invention preferably contains a resin component including a crosslinked resin obtained by curing a polymerizable compound that has at least an acryloyl group or a methacryloyl group, and inorganic fine particles treated with a surface treatment agent that has a polymerizable functional group.

Such a protective layer can re foraged as follows. A coating liquid for forming a protective layer is prepared by dissolving or dispersing in a publicly known solvent a polymerizable compound for forming a crosslinked resin, and a polymerization initiator and inorganic fine particles, as well as, as necessary, lubricant particles, an antioxidant, or a resin other than the crosslinked resin, which constitute the protective layer. The outer peripheral surface of an organic photosensitive layer is coated with the coating liquid for forming a protective layer to form a coating film. The coating film is dried, and irradiated with actinic rays such as ultraviolet rays and electron beams, so that the polymerizable compound in the coating film is subjected to a polymerization reaction, whereby a crosslinked resin is synthesized and cured.

The thickness of the protective layer is preferably 0.2 to 10 μm, more preferably 0.5 to 5 μm.

The protective layer can also be configured by using other publicly known resins in combination with the crosslinked resin.

As examples of other publicly known resins, may be mentioned polyester resins, polycarbonate resins, polyurethane resins, acrylic resins, epoxy resins, silicone resins, and alkyd resins.

### Polymerizable Compound:

The polymerizable compound for forming the crosslinked resin is not particularly limited. As examples thereof, may be mentioned styrene-based monomers, acrylic-based monomers, methacrylic-based monomers, vinyl toluene-based monomers, vinyl acetate-based monomers, and N-vinyl, pyrrolidone-based monomers. These polymerizable compounds may be used either singly or in any combination thereof.

A polymerisable compound having an acryloyl group (CH₂═CHCO—) or a methacryloyl group (CH₂═CCH₃CO—) as a polymerizable functional group is preferably used, since curing can be achieved by a small amount of light and for a short period of time. Since the crosslink density of the obtained crosslinked resin becomes high to improve abrasion resistance properties, a polymerizable compound having 2 to 6 polymerizable functional groups is particularly preferably used. These polymerizable compounds are described in Japanese Patent Application Laid-Open No. 2011-175140. Among those, part of the representative compounds is shown as an example below.

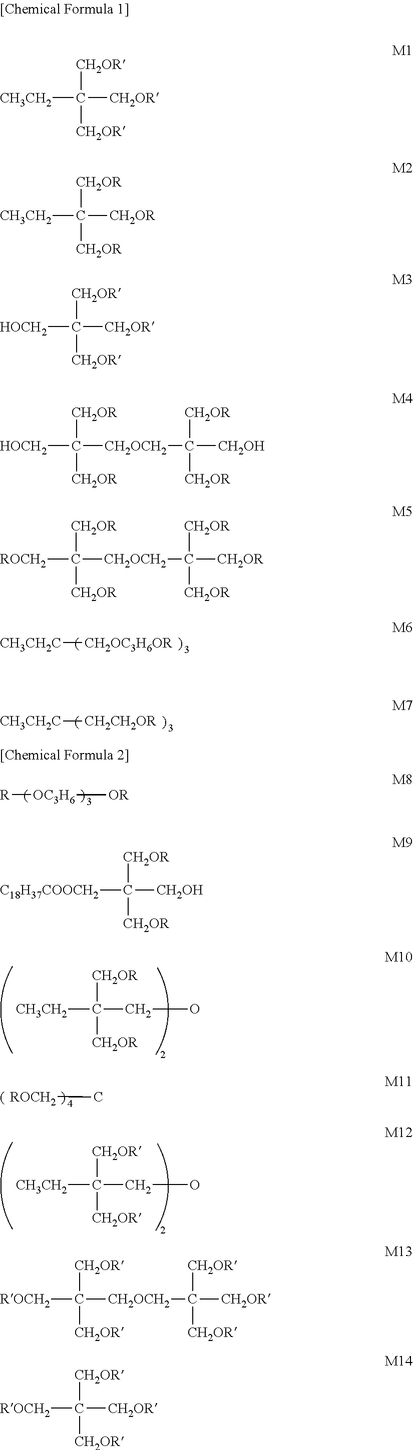

Here, R represents an acryloyl group (CH₂═CHCO—), and R′ represents a methacryloyl group (CH₂═CCH₃CO—).

### Inorganic Fine Particles:

The protective layer contains inorganic fine particles treated with a surface treatment agent having a polymerizable functional group. As the inorganic fine particles, may be used fine particles of metal oxides such as aluminum oxide (alumina: Al₂O₃), titanium oxide (titania: TiO₂), silicon oxide (silica: SiO₂), zirconium oxide (zirconia: ZrO₂), tin oxide (SnO₂), and zinc oxide (ZnO). Among these, aluminum oxide fine particles and tin oxide fine particles are preferably used.

The number average primary particle size of inorganic fine particles contained in the protective layer is preferably 1 to 300 nm, particularly preferably 3 to 100 nm. When the particle size is extremely small, abrasion resistance-improving performance is not sufficient. On the other hand, when the particle size is extremely large, a light emitted while an image is written is scattered, or a light curing reaction is inhibited while a surface layer is formed. Thus, abrasion resistance may also be adversely affected.

The number average primary particle size of the above described inorganic fine particles can be obtained as below. First, an enlarged picture with a magnification of 100,000 times is photographed by a scanning electron microscope (manufactured by JEOL Ltd. and the like). Then, based on a randomly scanned picture image including 300 particles (aggregated particles excluded), a number average primary particle size is calculated using an automatic image processing analyser “LUZEX (registered trademark) AP” (manufactured by Nireco Corporation), software version Ver. 1.32.

From the viewpoint of improvement in durability of a photoreceptor, inorganic fine particles contained in the protective layer is treated with a surface treatment agent having a polymerizable functional group.

A representative example cut the polymerizable functional group is a radically polymerizable functional group. Therefore, as a surface treatment agent, a compound having a radically polymerizable functional group and being capable of covering the surfaces of inorganic fine particles can be used. A particularly preferred radically polymerizable functional group is a reactive acryloyl or methacryloyl group. The portion of the group which bonds to the surface of the inorganic fine particle in order to cover the surface of inorganic fine particle has a structure as a silane coupling agent.

The surface treatment agent having a polymerizable functional group that can be preferably used in the present invention is a silane coupling agent having a reactive vinyl, acryloyl or methacryloyl group. An example thereof as a silane compound represented by a following general formula (1).

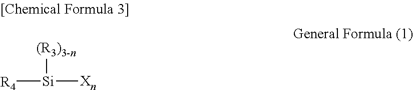

In the formula, R₃ represents a hydrogen atom, an alkyl group having 1 to 10 carbon atoms, or an aralkyl group having 1 to 10 carbon atoms; R₄ represents an organic group having a reactive double bond such as a vinyl group, an acryloyl group, or a methacryloyl group; and X represents a halogen atom, an alkoxy group, an acyloxy group, an aminoxy group, or a phenoxy group, n is an integer of 1 to 3.

Examples of the compounds represented by the general formula (1) described above are mentioned below.

S-1: CH₂═CHSi(CH₃)(OCH₃)₂

S-2: CH₂═CHSi(OCH₃)₃

S-3: CH₂═CHSiCl₃

S-4: CH₂═CHCOO(CH₂)₂Si(CH₃)(OCH₃)₂

S-5: CH₂═CHCOO(CH₂)₂Si(OCH₃)₃

S-6: CH₂═CHCOO(CH₂)₂Si(OC₂H₅)(OCH₃)₂

S-7: CH₂═CHCOO(CH₂)₃Si(OCH₃)₂

S-8: CH₂═CHCOO(CH₂)₂Si(CH₃)Cl₂

S-9: CH₂═CHCOO(CH₂)₂SiCl₃

S-10: CH₂═CHCOO(CH₂)₃Si(CH₃)Cl₂

S-11: CH₂═CHCOO(CH₂)₃SiCl₃

S-12: CH₂═C(CH₃)COO(CH₂)₂Si(CH₃)(OCH₃)₂

S-13: CH₂═C(CH₃)COO(CH₂)₂Si(OCH₃)₃

S-14: CH₂═C(CH₃)COO(CH₂)₃Si(CH₃)(OCH₃)₂

S-15: CH₂═C(CH₃)COO(CH₂)₃Si(OCH₃)₃

S-16: CH₂═C(CH₃)COO(CH₂)₂Si(CH₃)Cl₂

S-17: CH₂═C(CH₃)COO(CH₂)₂SiCl₃

S-18: CH₂═C(CH₃)COO(CH₂)₃Si(CH₃)Cl₂

S-19: CH₂═C(CH₃)COO(CH₂)₃SiCl₃

S-20: CH₂═CHSi(C₂H₅)(OCH₃)₂

S-21: CH₂═C(CH₃)Si(OCH₃)₃

S-22: CH₂═C(CH₃)Si(OC₂H₅)₃

S-23: CH₂═CHSi(OCH₃)₃

S-24: CH₂═C(CH₃)Si(CH₃)(OCH₃)₂

S-25: CH₂═CHSi(CH₃)Cl₂

S-26: CH₂═CHCOOSi(OCH₃)₃

S-27: CH₂═CHCOOSi(OC₂H₅)₃

S-28: CH₂═C(CH₃)COOSi(OCH₃)₃

S-29: CH₂═C(CH₃)COOSi(OC₂H₅)₃

S-30: CH₂═C(CH₃)COO(CH₂)₃Si(OC₂H₅)

These silane compounds may be used either singly or in any combination thereof.

The surface treatment of inorganic fine particles with a surface treatment agent having a polymerizable functional group is preferably performed by utilising 0.1 to 200 parts by mass of a silane compound as a surface treatment agent and 50 to 5000 parts by mass of a solvent per 100 parts by mass of inorganic fine particles, using a wet media dispersion-type apparatus.

Here, in the present invention, it can be checked that the surfaces of inorganic fine particles are coated with a surface treatment agent having a polymerizable functional group, by combining surface analysis methods such as a photoelectron spectroscopy (ESCA), an Auger electron spectroscopy (Auger), a secondary ion mass spectroscopy (SIMS), and a diffuse reflection FT-IR.

### Polymerization Initiator:

For initiating a polymerization reaction of the polymerizable compound used in the protective layer, may be used a method of initiating a reaction by electron beam cleavage, a method of adding a radical polymerization initiator to cause a reaction with light and heat, and the like. As the polymerization initiator, either a photopolymerization initiator or a thermal polymerization initiator may be used. Also, both the photopolymerization initiator and the thermal polymerization initiator can be used in combination.

As the radical polymerization initiator, a photopolymerization initiator is preferred. An alkylphenone-based compound or a phosphine oxide-based compound is preferred among others. Especially, a compound having an α-hydroxyacetophenone structure or an acyl phosphine oxide structure is preferred. Also, as examples of a compound that initiates cation polymerization, may be mentioned an ionic polymerization initiator such as B(C₆F₅)₄⁻, PF₆⁻, AsF₆⁻, SbF₆⁻ and CF₃SO₃⁻ salts of an aromatic onium compound such as diazonium, ammonium, iodonium, sulfonium and phosphonium; and a nonionic polymerization initiator such as a sulfonated product chat generates sulfonic acid, a halide that generates hydrogen halide, or an iron arene complex. Especially, a sulfonated product that generates sulfonic acid or a halide that generates hydrogen halide, which is a nonionic polymerization initiator, is preferred.

On the other hand, as the thermal polymerization initiator, may be used ketone peroxide-based compounds, peroxyketal-based compounds, hydroperoxide-based compounds, dialkyl peroxide-based compounds, diacyl peroxide-based compounds, peroxydicarbonate-based compounds or peroxyester-based compounds. These thermal polymerization initiators are disclosed in manufacturers' product catalogs and the like.

These polymerization initiators may be used either singly or in any combination thereof.

The added amount of the polymerization initiator is preferably 0.1 to 20 parts by mass, more preferably 0.5 to 10 parts by mass, per 100 parts by mass of a polymerizable compound. When the added amount of the polymerization initiator falls within this range, crosslinking of a resin in the protective layer is sufficiently promoted. Accordingly, the photoreceptor surface can have a universal hardness HU of 200 to 500 M/mm².

The universal hardness HU of the photoreceptor surface is a hardness value obtained by a surface coat physical property test using a Fisherscope H100V (trade name) manufactured by Fischer Instruments K.K, in accordance with ISO/FDIS 14577. The measurement is performed using a square pyramid diamond indenter with a defined face angle of 136°. Then, the indenter is subjected to a measurement load F (unit: N) in a stepwise manner to press a sample to be measured. A pressing depth h (unit: mm) in a state of being subjected to the load is electrically detected. Calculation is performed according to a formula (a) to obtain the above-described hardness value. Here, in the following formula (A), K equals to 1/26.43.

HU=K×F/h² [N/mm²] Formula (A):

### Charging Roller:

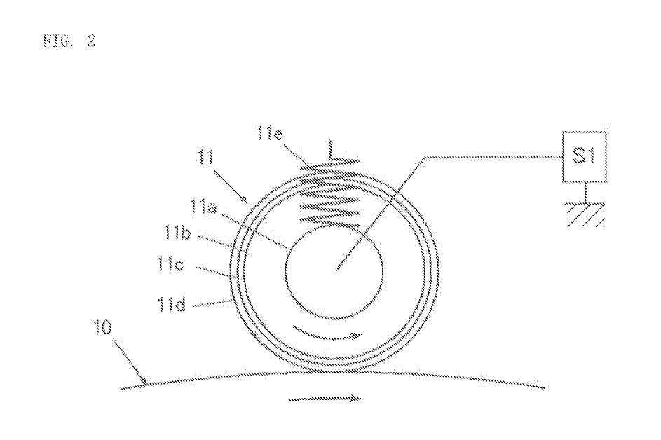

A charging roller 11 includes, as shown in FIG. 2, a cored bar 11a; an elastic layer 11b laminated on the surface of the cored bar 11a for reducing a charging sound while providing elasticity to obtain uniform adhesive properties to the photoreceptor 10; a resistance control layer 11c laminated on the surface of the elastic layer 11b so that the charging roller 11 obtains, as necessary, highly uniform electric resistance as a whole; a surface layer 11d laminated on the resistance control layer 11c; and a pressing spring 11e. The charging roller 11 is configured to be biased in a direction of the photoreceptor 10 by the pressing spring 11e and brought into pressure contact with the surface of the photoreceptor 10 at a predetermined pressing force to obtain a state where a charging nip part is formed. Also, the charging roller 11 is rotated driven by the rotation of the photoreceptor 10.

The cored bar 11a is made of, for example, a metal such as iron, copper, stainless, aluminum and nickel, or any of these metals having a surface that has been plated without losing conductivity in order to obtain rust preventive properties and scratch resistance. The outer diameter of the cored bar 11a is, for example, set to be 3 to 20 mm.

The elastic layer 11b is prepared by adding, for example, conductive particles including carbon black, carbon graphite and the like, and conductive salt particles including alkali mental salts, ammonium salts and the like, in an elastic material such as rubber. As specific examples of the elastic material, may be mentioned natural rubbers, synthetic rubbers such as, ethylene-propylene-diene-methylene rubbers (EPDM), styrene-butadiene rubbers (SBR), silicone rubbers, urethane rubbers, epichlorhydrin rubbers, isoprene rubbers (IR), butadiene rubbers (BR), nitrile-butadiene rubbers (NBR) and chloroprene rubbers (CR), resins such as polyamide resins, polyurethane resins, silicone resins and fluorine resins, and foams such as foam sponges. The degree of elasticity can be adjusted by adding a process oil, a plasticiser and the like in the elastic material.

The volume resistivity of the elastic layer 11b is preferably 1×10¹ to 1×10¹⁰Ω·cm. Also, the layer thickness thereof is preferably 500 to 5000 μm, more preferably 500 to 3000 μm.

The volume resistivity of the elastic layer 11b is a value measured in accordance with JIS K 6911.

The resistance control layer 11c is provided so that, for example, the charging roller 11 has uniform electric resistance as a whole. However, the resistance control layer 11c may not be necessarily provided. The resistance control layer 11c can be provided by coating the surface of the elastic layer 11b with a material having appropriate conductivity, or covering the surface of the elastic layer 11b with a tube having appropriate conductivity.

As a specific material constituting the resistance control layer 11c, may be mentioned a basic material with a conductive agent added therein. Examples of the basic material may include resins such as polyamide resins, polyurethane resins, fluorine resins, and silicone resins; and rubbers such as epichlorhydrin rubbers, urethane rubbers, chloroprene rubbers, and acrylonitrile-based rubbers. Examples of the conductive agent may include conductive fine particles containing carbon black, carbon graphite, or the like; conductive metal oxide fine particles containing conductive titanium oxide, conductive zinc oxide, conductive tin oxide, or the like; and conductive salt fine particles containing alkali metal salts, ammonium salts or the like.

The volume resistivity of the resistance control layer 11c is preferably 1×10⁻² to 1×10¹⁴ Ω·cm, more preferably 1×10¹ to 1×10¹⁰ Ω·cm. Also, the layer thickness thereof is preferably 0.5 to 100 μm, more preferably 1 to 50 μm, further preferably 1 to 20 μm.

The volume resistivity of the resistance control layer 11c is a value measured in accordance with JIS K 6911.

The surface layer 11d is provided for the purpose of, for example, inhibiting bleed-out of a plasticizer contained in the elastic layer 11b onto the surface of tin obtained charging roller; obtaining sliding properties and smoothness of a charging roller; or inhibiting generation of leakage even when there is a defect such as a pinhole on the photoreceptor 10. The surface layer 11d can be disposed by coating with a material having appropriate conductivity, or covering with a tubs having appropriate conductivity.

When the surface layer 11d is disposed by coating with a material, as specific materials, may be mentioned a basic material with a conductive agent added therein. Examples of the basic material may include resins such as polyamide resins, polyurethane resins, acrylic resins, fluorine resins, and silicone resins; and rubbers such as epichlorhydrin in rubbers, urethane rubbers, chloroprene rubbers, and acrylonitrile-based rubbers. Examples of the conductive agent may include conductive fine particles containing carbon black, carbon graphite, or the like; and conductive metal oxide fine particles containing conductive titanium oxide, conductive zinc oxide, conductive tin oxide, or the like. As a coating method, may be mentioned a dip coating method, a roll coating method, and a spray coating method.

Also, as a specific tube used when the surface layer 11d is disposed by covering with a tube, may be mentioned nylon 12, tetrafluoroethylene-perfluoroalkylvinylether copolymer resins (PFA), polyvinylidene fluoride, and tetrafluoroethylene-hexafluoropropylene copolymer resins (FEP); and a thermoplastic elastomer including the above-described conductive agents added therein and being molded into a tube shape. The thermoplastic elastomer may be based on polystyrene, polyolefin, polyvinyl chloride, polyurethane, polyester, polyamide, and the like. The tube may or may not have heat-shrinkable properties.

The volume resistivity of the surface layer 11d is preferably 1×10¹ to 1×10⁸ Ω·cm, more preferably 1×10¹ to 1×10⁵ Ω·cm. Also, the layer thickness thereof is preferably 0.5 to 100 μm, more preferably 1 to 50 μm, further preferably 1 to 20 μm.

The volume resistivity of the surface layer 11d is a value measured in accordance with JIS K 6911.

The surface roughness Rz of the surface layer 11d is preferably 1 to 30 μm, more preferably 2 to 20 μm, further preferably 5 to 10 μm.

In the charging roller 11 as described above, the cored bar 11a of the charging roller 11 is applied with a charging bias voltage by a power source S1, so that the surface of the photoreceptor 10 is charged with a predetermined potential and a predetermined polarity. Here, the charging bias voltage can be defined as, for example, an oscillating voltage with a DC voltage (Vdc) superimposed by an AC voltage (Vac).

In an example of the charging condition by the charging roller shown in FIG. 2, a charging bias voltage is a sine wave formed by a DC voltage (Vdc) of −500 V, an AC voltage (Vac) at a frequency of 1.000 Hz, and an inter-peak voltage of 1300 v. By applying this charging bias voltage, the surface of the photoreceptor 10 is uniformly charged at −500 V.

The charging roller 11 may have a length based on the longitudinal length of the photoreceptor 10, and the longitudinal length can be determined to be, for example, 320 mm.

### Cleaning Blade:

The cleaning blade 18 used in the image forming method of the present invention is preferably made of a rubber material that is an elastic body. As examples of the rubber material, may be mentioned urethane rubbers, silicon rubbers, fluorine rubbers, chloropyrene rubbers and butadiene rubbers. Among these, urethane rubbers are especially preferably used in view of excellent abrasion properties compared to other rubbers.

The shape and material properties of the cleaning blade 13 can be appropriately determined depending on various conditions such as toner properties, photoreceptor properties, and the abutting angle and abutting pressure of an intermediate transfer body, a secondary transfer body and cleaning blade 18.

In the image forming apparatus, a toner image formed on the photoreceptor 10 is timely delivered and transferred on the transfer material P by the transferring unit 14. Thereafter, the image is separated from the photoreceptor 10 by the separation unit 16, and fixed in the fixing unit 17, whereby forming a visible image.

The image forming apparatus used in the image forming method of the present invention is not limited to those with the above-mentioned structure, and may be a color image forming apparatus having a structure in which image formation units associated with a plurality of photoreceptors are disposed along an intermediate transfer body.

According to the image forming method of the present invention as described above, an external additive is added in toner base particles. The external additive contains at least first external additive particles that include a specific polytetrafluoroethylene with a low molecular weight, and second external additive particles that include at least one selected from a fatty acid metal salt and an amide wax. Accordingly, excellent cleaning properties are obtained for a long period of time even when the process is employed to an image forming apparatus with a charging roller for charging a photoreceptor, and a favorable image can be formed while inhibiting occurrence of a black spots-like image defect even in a high temperature and high humidity environment.

As described above, the embodiments of the present invention have been specifically described. However, embodiments of the present invention should not be limited to the above-described embodiments, and various modifications can be made thereto.

### EXAMPLES

Although specific examples of the present invention will be described below, the present invention should not be limited to these examples.

### Toner Preparation

### Example 1

### (1) Formation of Colored Particles (Toner Base Particles)

### (1-1) Preparation Step of Core Part Resin Fine Particles [1]:

Core part resin fine particles [1] having a multi-layer structure were prepared via a first stage polymerisation, a second stage polymerization, and a third stage polymerization described below.

### (a) First Stage Polymerization (Resin Fine Particles [A1]):

In a 5 L reaction vessel equipped with a stirrer, a temperature sensor, a condenser and a nitrogen-introducing device, a surfactant solution of 4 parts by mass of sodium polyoxyethylene-2-dodecyl ether sulfate dissolved in 3040 parts by mass of ion exchanged water was charged. The internal temperature of the solution was increased to 80° C. while stirring at a stirring rate of 230 rpm under a nitrogen gas stream. Into the surfactant solution, a polymerization initiator solution of 10 parts by mass of a polymerization initiator (potassium persulfate: KPS) dissolved in 400 parts by mass of ion exchanged, water was added, and the temperature was set at 75° C. Thereafter, a monomer mixed liquid including 532 parts by mass of styrene, 200 parts by mass of n-butylacrylate, 68 parts by mass of methacrylic acid, and 16.4 parts by mass of n-octyl mercaptan was dropwisely added, thereto for one hour. This system was heated and stirred at 75° C. for 2 hours for performing polymerization (first stage polymerisation), thereby preparing resin fine particles [A1]. Here, the weight average molecular weight (Mw) of the resin fine particles [A1] prepared in the first stage polymerisation, was 16,500.

For measuring the weight average molecular weight (Mw), using “HLC-8220” (manufactured by Tosoh Corporation) and a column “TSK guard column+TSK gel Super HZM-M 3 in series” (manufactured by Tosoh Corporation), tetrahydrofuran (THF) is flown as a carrier solvent at a flow rate of 0.2 ml/min while maintaining the column temperature at 40° C. Under the dissolution condition of treating a measurement sample using an ultrasonic dispersion machine at room temperature for 5 minutes, the measurement sample is dissolved in tetrahydrofuran so that the solution has a concentration of 1 mg/ml. Next, a treatment is performed with a membrane filter having a pore size of 0.2 μm to obtain a sample solution. Then, 10 μl of this sample solution is injected in the apparatus together with the above-described carrier solvent, and detection is performed using a refractive index detector (an RI detector). The molecular weight distribution of the measurement sample is calculated using a calibration curve measured with monodispersed polystyrene standard particles. The used standard polystyrene samples for measuring a calibration curve are manufactured by Pressure Chemical Company and have a molecular weight of 6×10², 2.1×10³, 4×10³, 1.75×10⁴, 5.1×10⁴, 1.1×10⁵, 3.9×10⁶, 8.6×10⁵, 2×10⁶, and 4.48×10⁶, respectively. At least approximately 10 standard polystyrene samples were measured, and calibration curves were prepared. Also, a refractive index detector was used as a detector.

### (b) Second Stage Polymerization (Resin Fine Particles [A2]: Formation of Intermediate Layer):

In a flask equipped with a stirrer, 93.8 parts by mass of a paraffin wax “HNP-57” (manufactured by Nippon Seiro Co., Ltd.) was added as a parting agent in a monomer mixed liquid including 101.1 parts by mass of styrene, 62.2 parts by mass of n-butylacrylate, 12.3 parts by mass of methacrylic acid, and 1.75 parts by mass of n-octyl mercaptan. The mixture was heated to 90° C. for dissolution.

On the other hand, a surfactant solution of 3 parts by mass of sodium polyoxyethylene-2-dodecyl ether sulfate dissolved in 1560 parts by mass of ion exchanged water was heated to 98° C. Into this surfactant solution, 32.8 parts by mass (based on solid content) of the above-described resin fine particles [A1] was added. Using a mechanical disperser “Clear Mix” (manufactured by M Technique Co., Ltd.) having a circulation path, the above-described monomer solution containing the paraffin wax was mixed and dispersed for 8 hours. Thus, a dispersion liquid containing emulsified particles having a dispersion particle size of 340 nm was prepared. Next, a polymerization initiator solution of 6 parts by mass of potassium persulfate dissolved in 200 parts by mass of ion exchanged water was added in the dispersion liquid of emulsified particles. This system was heated and stirred at 98° C. for 12 hours for performing polymerization (second stage polymerization), thereby preparing resin fine particles [A2]. The weight average molecular weight (Mw) of the resin fine particles [A2] prepared in the second stage polymerization was 23,000.

### (c) Third Stage Polymerization (Core Part Resin Fine Particles [1]: Formation of Outer Layer):

A polymerization initiator solution of 5.45 parts by mass of potassium persulfate dissolved in 220 parts by mass of ion exchanged water was added in the above-described resin fine particles [A2]. A monomer mixed liquid including 293.8 parts by mass of styrene, 154.1 parts by mass of n-butylacrylate, and 7.08 parts by mass of n-octyl mercaptan was dropwisely added for one hour under the temperature condition of 80° C. After completion of dropwise addition, heating and stirring were performed for 2 hours for performing polymerization (third stage polymerization). Thereafter, the temperature was decreased to 28° C. to obtain core part resin fine particles [1]. Here, the weight average molecular weight (Mw) of the core part resin fine particles [1] was 26,800. Also, the volume average particle size of the core part resin fine particles [1] was 125 nm. Furthermore, the glass transition point (Tg) of the core part resin fine particles was [1] was 28.1° C.

### (1-2) Preparation Step of Shell Layer Resin Fine Particles [1]:

A polymerization reaction and a treatment after the reaction were performed in the same manner as in the preparation of the core part resin fine particles [1], except that a monomer mixed liquid including 548 parts by mass of styrene, 156 parts by mass of 2-ethylhexyl acrylate, 96 parts by mass of methacrylic acid, and 16.5 parts by mass of n-octyl mercaptan was used instead in the first stage polymerization of the core part resin fine particles [1]. Thus, shell layer resin, fine particles [1] were prepared. Here, the glass transition point (Tg) of the shell layer resin fine particles [1] was 53.0° C.

### (1-3) Preparation of Colorant Fine Particle Dispersion Liquid:

In 1600 parts by mass of ion exchanged water, 90 parts by mass of sodium dodecyl sulfate was added. While stirring the solution, 420 parts by mass of carbon black “Regal 330R” (manufactured by Cabot Corporation) was gradually added. Next, a dispersion treatment was performed using a stirrer “Clear Mix” (manufactured by M Technique Co., Ltd.) to prepare a colorant fine particle dispersion liquid [1] in which colorant fine particles are dispersed.

The particle size of the colorant fine particles in the colorant fine particle dispersion liquid [1] was measured using an electrophoretic light scattering spectrophotometer “ELS-800” (manufactured by Otsuka Electronics Co., Ltd.), and was found to be 110 nm.

### (1-4) Preparation of Toner Base Particles [1]:

### (a) Formation of Core Part [1]:

In a reaction vessel equipped with a temperature sensor, a condenser, a nitrogen-introducing device, and a stirrer, 420 parts by mass (based on solid content) of the core part resin fine particles [1], 900 parts by mass of ion exchanged water, and 100 parts by mass of the colorant fine particle dispersion liquid [1] were placed and stirred. After the temperature in the reaction vessel was adjusted at 30° C., 5 mol/l of an aqueous sodium hydroxide solution was added in this solution to adjust pH at 8 to 11.

Next, in the obtained product, an aqueous solution of 60 parts by mass of magnesium chloride hexahydrate dissolved in 60 parts by mass of ion exchanged water was added under stirring at 30° C. for 10 minutes. After the mixture was left to stand for 3 minutes, the temperature started to be increased. The temperature of this system was increased to 80° C. (core part formation temperature) for 80 minutes. In this state, the particle size of the particles was measured by “Coulter Multisizer 3” (manufactured by Coulter). When the volume-based median diameter (D₅₀) of the particles reached 5.8 μm, an aqueous solution of 40.2 parts by mass of sodium chloride dissolved in 1000 parts by mass of ion exchanged water was added to stop the growth of the particle size. Furthermore, heating and stirring were performed as an aging treatment at a liquid temperature of 80° C. (core part aging temperature) for one hour to continue fusion, thereby forming a core part [1]. Here, the roundness of the core part [1] was measured by “FPIA 2100” (manufactured by Sysmex Corporation), and was found to be 0.930. Also, the core part [1] was observed at a magnification of 10000 times in a scanning transmission electron microscopy using a field emission-scanning electron microscope JSM-7401F (manufactured by JEOL Ltd.). In this observation, it was confirmed that a colorant was dissolved in a binder resin, and colorant dispersion fine particles did not remain.

### (b) Formation of Shell Layer:

Next, 46.8 parts by mass (based on solid content) of the shell layer resin fine particles [1] were added at 65° C. Furthermore, an aqueous solution of 2 parts by mass of magnesium chloride hexahydrate dissolved in 60 parts by mass of ion exchanged water was added for 10 minutes. Thereafter, the temperature was increased to 80° C. (shell formation temperature), and stirring was continued for one hour. Thus, the shell layer resin fine particles [1] were fused on the surface of the core part [1]. Thereafter, an aging treatment was performed at 80° C. (shell aging temperature) until a predetermined roundness was obtained, thereby forming a shell layer. Here, an aqueous solution of 40.2 parts by mass of sodium chloride dissolved in 1000 parts by mass of ion exchanged water was added and the system was cooled to 30° C. under the temperature decrease condition of 8° C./min. The generated fused particles were filtrated off, and repeatedly washed with ion exchanged water at 45° C. Thereafter, the particles were dried with hot air at 40° C. Thus, toner base particles [1] having a shell layer on she surface of a core part were obtained. The toner base particles [1] had a volume-based median diameter (D₅₀) of 5.9 μm and a glass transition point (Tg) of 31° C.

### (2) Addition of External Additives

In 100 parts by mass of the dried toner base particles [1], 0.15 parts by mass of polytetrafluoroethylene (average: molecular weight: 1,000, particle size: 1 μm), 0.15 parts by mass of zinc stearate (particle size: 1 μm), and 1 part by mass of negatively charged silica “RX-200 (manufactured by Nippon Aerosil Co., Ltd.)” and 1 part by mass of negatively charged silica “NX90 (manufactured by Nippon Aerosil Co., Ltd.)” were added. Using a Henschel mixer (manufactured by Nippon Coke & Engineering Company, Limited), a mixing treatment was performed at a rotor peripheral speed of 35 m/sec and a treatment temperature of 32° C. for 20 minutes. Thereafter, coarse particles were removed using a sieve having an opening of 45 μm to prepare a toner [1].

### Photoreceptor Preparation Example 1

### Preparation of Conductive Support

The surface of a drum-shaped aluminum support having a diameter of 60 mm was subjected to cutting work to prepare a conductive support with a finely coarse surface.

### Formation of Intermediate Layer:

A dispersion liquid having the below-described composition was diluted twice with the same mixed solvent, and left to stand overnight. Then, the dispersion liquid was filtrated using a Ridimesh 5 μm filter manufactured by Nihon Pall Ltd, whereby an intermediate layer coating liquid was prepared.
1 part by mass of poliamide resin (CM8000: manufactured by Toray Industries, Inc.)
3 parts by mass of titanium oxide (SMT500SAS: manufactured by Tayca Corporation)
10 parts by mass of methanol

They were dispersed in a batchwise manner for 10 hours using a sand mill as a disperser.

The above-described conductive support was coated with the intermediate layer coating liquid in a dip coating method so as to achieve a dry film thickness of 2 μm, and dried, thereby forming an intermediate layer.

### Formation of Charge Generating Layer:

20 parts by mass of charge generating substance: pigment [CG-1] as described below
10 parts by mass of polyvinyl butyral resin (#6000-C: manufactured by Denki Kagaku Kogyo Kabushiki Kaisha)
700 parts by mass of t-butyl acetate
300 parts by mass of 4-methoxy-4-methyl-2-pentanone

They were mixed, and the mixture was dispersed using a sand mill for 10 hours, thereby preparing a charge generating layer coating liquid. The above-described intermediate layer was coated with this charge generating layer coating liquid in a dip coating method, and dried, thereby forming a charge generating layer having a dry film thickness of 0.3 μm.

### Synthesis of Pigment (CG-1)

### (1) Synthesis of Amorphous Titanyl Phthalocyanine

In 200 parts by mass of ortho-dichlorbenzene, 29.2 parts by mass of 1,3-diiminoisoindoline was dispersed. In the dispersion, 20.4 parts by mass of titanium tetra-n-butoxide was added. The mixture was heated under a nitrogen atmosphere at 150 to 160° C. for 5 hours. After the heated mixture was left to cool down, deposited crystals were filtrated, washed with chloroform, washed with 2% aqueous hydrochloric acid, washed with water, and washed with methanol. The obtained product was dried to obtain 26.2 parts by mass (yield 91%) of crude titanyl phthalocyanine.

Next, this crude titanyl phthalocyanine was added in 250 parts by mass of concentrated sulfuric acid, and stirred at not higher than 5° C. for one hour for dissolution. This solution was poured in 5000 parts by mass of water at 20° C., and deposited crystals were filtrated. Sufficient washing with water was performed to obtain 225 parts by mass of a wet paste product. This was frozen in a freezer, and thawed. Thereafter, filtering and drying were performed to obtain 24.8 parts by mass (yield 86%) of amorphous titanyl phthalocyanine.

### (2) Synthesis of (2R,3R)-2,3-butanediol adduct titanyl phthalocyanine [CG-1]

In 200 parts by mass of ortho-dichlorobenzene, 10.0 parts by mass of the amorphous titanyl phthalocyanine and 0.94 parts by mass (equivalent ratio to amorphous titanyl phthalocyanine=0.6) of (2R,3R)-2,3-butanediol were mixed. This mixture was heated and stirred at 60 to 70° C. for 6.0 hours. After the mixture was left to stand overnight, methanol was added in the reaction solution to cause generation of crystals. The crystals were filtrated, and washed with methanol, thereby obtaining 10.3 g of a pigment (a pigment containing (2R,3R)-2,3-butanediol adduct titanyl phthalocyanine) [CG-1].

The X-ray diffraction spectrum of this [CG-1] was measured, and the peaks were clearly observed at 8.3°, 24.7°, 25.1°, and 26.5°. The mass spectrum thereof was measured, and the peaks were observed at 576 and 648. The IR spectrum thereof was measured, and the Ti═O absorption appeared around 970 cm⁻¹, while both absorptions of O—Ti—O appeared around 636 cm⁻¹. The thermal analysis (TG) thereof was performed, and there was approximately 7% reduction in mass from 390 to 410° C. From the above results, it was estimated that the [CG-1] was a mixed crystal of a 1.1 adduct of titanyl phthalocyanine and (2R,3R)-2,3-butanediol and unadducted (non-abducted) titanyl phthalocyanine.

The BET specific surface area of this [CG-1] was measured, and found to be 31.2 m²/g.

The X-ray diffraction spectrum was measured using a sample obtained by coating a transparent glass plate with [CG-1] and drying the coated plate. Also, the BET specific surface area was measured using an automatic fluid-type specific surface area measurement apparatus “Micrometrics Flowsorb type” (manufactured by Shimadzu Corporation).

### Formation of Charge Transport Layer:

225 parts by mass of a charge transport substance (Compound A as described below)
300 parts by mass of a binder: polycarbonate Z (Z300: manufactured by Mitsubishi Gas Chemical Company Inc.)
6 parts by mass of an antioxidant (Irganox 1010: manufactured by Nihon Ciba-Geigy K.K.)
1600 parts by mass of THF (tetrahydrofuran)
400 parts by mass of toluene
1 part by mass of silicone oil (KF-50: manufactured by Shin-Etsu Chemical Co., Ltd.)

They were mixed and dissolved to prepare a charge transport layer coating liquid.

The above-described charge generating layer was coated with this coating liquid using a circular slide hopper coating apparatus, thereby forming a charge transport layer having a dry film thickness of 20 μm.

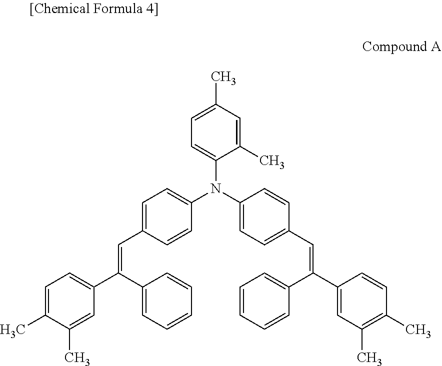

### Formation of Protective Layer:

First, inorganic fine particles were subjected to a surface treatment using a surface treatment agent having a polymerizable functional group in the following manner.

A mixed liquid containing 100 parts by mass of tin oxide (manufactured by CIK Nanotek Corporation, number average primary particle size: 20 nm, volume resistivity: 1.05×10⁵ (Ω·cm)) as inorganic fine particles, 30 parts by mass of the above-described example compound S-15: CH₂-C(CH₃)COO(CH₂)₃Si(OCH₃)₃) as the surface treatment agent, and 300 parts by mass of a mixed solvent of toluene/isopropyl alcohol in a ratio of 1/1 (by mass) were placed in a sand mill together with zirconia beads. The mixture was stirred at approximately 40° C. and a rotation rate of 1500 rpm. Furthermore, the above-described process mixture was removed, placed in a Henschel mixer, and stirred at a rotation rate of 1500 rpm for 15 minutes. Thereafter, drying was performed at 120° C. for 3 hours to perform a surface treatment with a compound having a polymerizable functional group with respect to tin oxide, whereby a surface-treated tin oxide was obtained.

Due to this surface treatment, the surfaces of tin oxide particles were coated with the example compound (S-15).
80 parts by mass of surface-treated tin oxide
100 parts by mass of a polymerizable compound (Example Compound M1 above)
20 parts by mass of a charge transport substance (Compound B as described below)
10 parts by mass of a polymerization initiator (IRGACURE 819: manufactured by BASF Japan Ltd.)
320 parts by mass of 2-butanol
80 parts by mass of tetrahydrofuran

The composition of a coating liquid including these components were mixed and stirred to be sufficiently dissolved or dispersed, thereby preparing a coating liquid for forming a protective layer. The charge transport layer was coated with this coating liquid for forming a protective layer using a circular slide hopper coating apparatus. After the coating, UV rays were irradiated for one minute using a metal halide lamp to form a protective layer having a dry film thickness of 3.0 μm, thereby producing a photoreceptor [1].

The universal hardness HU of the surface of the obtained photoreceptor [1] was measured in the foregoing method, and found to be 240 N/mm².

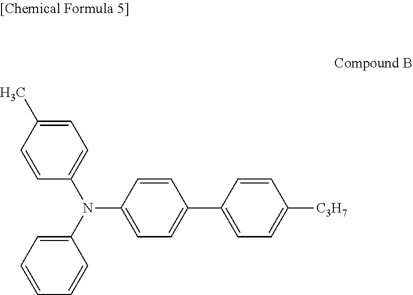

### Toner Preparation Examples 2 to 21

Toners [2] to [21] were prepared in the same manner as in the toner preparation example 1, except that external additives according to the formulation in the following TABLE 1 were used in the step of (2) addition of external additives in the toner preparation example 1.

TABLE 1

| | | Polytetrafluoroethylene | | Fatty acid metal or amide wax | | Other additives | |
|---|---|---|---|---|---|---|---|
| | Toner | Molecular | Added amount | | Added amount | | Added amount |
| | No. | weight | (parts by mass) | Type | (parts by mass) | Type | (parts by mass) |
| Example 1 | 1 | 1,000 | 0.15 | Zinc stearate | 0.15 | — | — |
| Example 2 | 2 | 1,000 | 0.01 | Zinc stearate | 0.15 | — | — |
| Example 3 | 3 | 1,000 | 1 | Zinc stearate | 0.15 | — | — |
| Example 4 | 4 | 500 | 0.15 | Zinc stearate | 0.15 | — | — |
| Example 5 | 5 | 5,000 | 0.15 | Zinc stearate | 0.15 | | |
| Example 6 | 6 | 20,000 | 0.15 | Zinc stearate | 0.15 | — | — |
| Example 7 | 7 | 1,000 | 0.15 | Zinc stearate | 0.01 | — | — |
| Example 8 | 8 | 1,000 | 0.15 | Zinc stearate | 0.5 | — | — |
| Example 9 | 9 | 1,000 | 0.15 | Zinc stearate | 0.15 | — | — |
| Example 10 | 10 | 1,000 | 0.15 | Methylenebis stearic acid amide | 0.15 | — | — |
| Example 11 | 11 | 1,000 | 0.15 | Calcium stearate | 0.15 | — | — |
| Example 12 | 12 | 1,000 | 0.15 | Ethylenebis capric acid amide | 0.15 | — | — |
| Example 13 | 13 | 1,000 | 0.05 | Zinc stearate | 0.15 | Calcium titanate | 0.5 |
| Example 14 | 14 | 1,000 | 0.05 | Methylenebis stearic acid amide | 0.15 | Calcium titanate | 0.5 |
| Comparative | 15 | 1,000 | 0.15 | — | — | — | — |
| Example 1 | | | | | | | |
| Comparative | 16 | 450 | 0.15 | Zinc stearate | 0.15 | — | — |
| Example 2 | | | | | | | |
| Comparative | 17 | 21,800 | 0.15 | Zinc stearate | 0.15 | — | — |
| Example 3 | | | | | | | |
| Comparative | 18 | 1,000 | 0.15 | Zinc stearate | 0.6 | — | — |
| Example 4 | | | | | | | |
| Comparative | 19 | 1,000 | 0.15 | Zinc stearate | 0.009 | Calcium titanate | 0.5 |
| Example 5 | | | | | | | |
| Comparative | 20 | — | — | Zinc stearate | 0.15 | — | — |
| Example 6 | | | | | | | |
| Comparative | 21 | — | — | Methylenebis stearic acid amide | 0.15 | — | — |
| Example 7 | | | | | | | |

### Production of Developer:

A ferrite carrier that was coated with a silicone resin and had a volume average particle size of 35 μm was mixed with each of the toners [1] to [21] so as to achieve a toner concentration of 7.5% by mass, thereby preparing developers [1] to [21],

### Examples 1 to 14 and Comparative Examples 1 to 7

A charging unit in a digital color multifunction printer “Bizhub C360” (manufactured by Konica Minolta Business Technologies, Inc.) was modified so as to have a charging roller system as shown in FIG. 1. The above-described photoreceptor [1] was mounted as a photoreceptor. Each of the developers [1] to [21] was loaded to this modified machine, and image formation was performed using one machine. Then, image defects and cleaning properties sere evaluated.

A charging roller that was made of a nylon resin and had a diameter of 1.0 cm was used as the charging roller.

A cleaning blade was arranged so as to have an angle with a photoreceptor of 7.5° and an abutting pressure of 7.0 gf/mm².

### (1) Image Defects:

Using the above-described image forming apparatus to which the developers [1] to [21] were loaded in turns, an image having a pixel rate of 10% was successively printed on 1,000 A4 high quality paper sheets (64 g/m²) in a high temperature and high humidify environment (temperature 30° C. and humidity 85% RH). It was visually inspected whether or not a black spots-like image defect occurred for each printing. The proportion (x/1000)×100 of print numbers x associated with a black spots-like image defect was regarded as an image defect occurrence rate. Based on the image defect occurrence rate, evaluation was performed regarding image defect occurrence. The results are shown in TABLE 2. In the present invention, when the image defect occurrence rate is lower than 0.5%, determination is made as being qualified.

### (2) Cleaning Properties:

Using the above-described image forming apparatus to which the developers [1] to [21] were loaded in turns, an image having a pixel rate of 5% was successively printed on 100,000 A4 high qualify paper sheets (64 g/m²) in a low temperature and low humidity environment (temperature 10° C. and humidity 10% RH). Thereafter, a solid test image (grid voltage: 450 V, development potential: 350 V) was output. This solid image and the photoreceptor were visually observed for evaluation. A cleaning Place was arranged so as to have an angle with a photoreceptor or 7.5° and a variable abutting pressure of 4.0 to 7.0 gf/mm².

The results are shown in TABLE 2. In the present invention, when there is no toner leakage on a test image under an abutting pressure of a cleaning blade of not higher than 7.0 gf/mm² (if “A” or “B”), it is determined that there is no practical problem.

### —Evaluation Criteria—

A: No toner leakage visually observed on a test image under an abutting pressure of 4.0 gf/mm².

B: No toner leakage visually observed on a test image under an abutting pressure of 7.0 gf/mm².

C: Toner leakage visually observed on a test image under an abutting pressure of 7.0 gf/mm².

TABLE 2

| | | Evaluation results | | |
|---|---|---|---|---|
| | Toner | Image defect occurence | | |
| | No. | rate (%) | Cleaning properties | |
| Example 1 | 1 | 0 | A | OK at 4.0 gf/mm² |
| Example 2 | 2 | 0.2 | B | OK at 7.0 gf/mm² |
| Example 3 | 3 | 0 | A | OK at 4.0 gf/mm² |
| Example 4 | 4 | 0 | B | OK at 7.0 gf/mm² |
| Example 5 | 5 | 0 | A | OK at 4.0 gf/mm² |
| Example 6 | 6 | 0 | B | OK at 7.0 gf/mm² |
| Example 7 | 7 | 0 | B | OK at 7.0 gf/mm² |
| Example 8 | 8 | 0.3 | A | OK at 4.0 gf/mm² |
| Example 9 | 9 | 0.4 | B | OK at 7.0 gf/mm² |
| Example 10 | 10 | 0 | B | OK at 7.0 gf/mm² |
| Example 11 | 11 | 0 | B | OK at 7.0 gf/mm² |
| Example 12 | 12 | 0 | B | OK at 7.0 gf/mm² |
| Example 13 | 13 | 0 | A | OK at 4.0 gf/mm² |
| Example 14 | 14 | 0 | A | OK at 4.0 gf/mm² |
| Comparative | 15 | 0 | C | NG at 7.0 gf/mm² |
| Example 1 | | | | |
| Comparative | 16 | 0 | C | NG at 7.0 gf/mm² |
| Example 2 | | | | |
| Comparative | 17 | 0 | C | NG at 7.0 gf/mm² |
| Example 3 | | | | |
| Comparative | 18 | 3 | A | OK at 4.0 gf/mm² |
| Example 4 | | | | |
| Comparative | 19 | 0 | C | NG at 7.0 gf/mm² |
| Example 5 | | | | |
| Comparative | 20 | 0 | C | NG at 7.0 gf/mm² |
| Example 6 | | | | |
| Comparative | 21 | 0 | C | NG at 7.0 gf/mm² |
| Example 7 | | | | |

### REFERENCE SIGNS LIST

10 Photoreceptor
11 Charging roller
11a Cored bar
11b Elastic layer
11c Resistance control layer
11d Surface layer
11e Pressing spring
12 Exposing unit
13 Developing unit
131 Development sleeve
14 Transferring unit
16 Separation unit
17 Fixing unit
18 Cleaning blade
P Transfer material

1. An image forming method comprising a charging step of charging a photoreceptor, an exposing step of exposing the charged photoreceptor to light to form an electrostatic latent image, a developing step of developing the electrostatic latent image with a toner for electrostatic image development, a transferring step of transferring the developed toner image on a transfer material, and a cleaning step of cleaning a surface of the photoreceptor by a cleaning blade after transferring of the toner image, wherein
charging the photoreceptor in the charging step is performed by a charging roller;
the toner for electrostatic image development, which is used in the developing step, includes an external additive added to toner base particles, and the external additive contains at least first external additive particles composed of a polytetrafluoroethylene and second external additive particles composed of at least one selected from a fatty acid metal salt and an amide wax;
the polytetrafluoroethylene constituting the first external additive particles has a number average molecular weight of 500 to 20,000; and
the second external additive particles are added in a ratio of 0.01 to 0.5 parts by mass per 100 parts by mass of the toner base particles.

2. The image forming method according to claim 1, wherein the number average molecular weight of the polytetrafluoroethylene constituting the first external additive particles is 1,000 to 5,000.

3. The image forming method according to claim 1, wherein the polytetrafluoroethylene constituting the first external additive particles is added in an amount of 0.01 to 1.0 parts by mass per 100 parts by mass of the toner base particles.

4. The image forming method according to claim 1, wherein the external additive further contains calcium titanate particles.

5. The image forming method according to claim 1, wherein the photoreceptor has an organic photosensitive layer and a protective layer on the organic photosensitive layer, and
the protective layer contains a resin component obtained by curing a polymerizable compound that has at least any one of an acryloyl group and a methacryloyl group, and inorganic fine particles treated with a surface treatment agent that has a polymerizable functional group.

6. The image forming method according to claim 1, wherein the first external additive particles have a number average particle size of 0.5 to 20 μm.

7. The image forming method according to claim 1, wherein the second external additive particles is added in an amount of 0.01 to 0.5 parts by mass per 100 parts by mass of the toner base particles.

8. The image forming method according to claim 1, wherein a ratio by mass between the added amount of the first external additive particles and the added amount of the second external additive particles, i.e., (the added amount of the first external additive particles/the added amount of the second external additive particles), is 0.1 to 10.

9. The image forming method according to claim 1, wherein the second external additive particles have a number average particle size of 0.5 to 20 μm.
